(19) United States
(12) Patent Application Publication
(10) Pub. No.: US 2026/0356275 A1
(43) Pub. Date: Nov. 12, 2026

(54) RATCHET STRAP ORGANIZATION SYSTEM

(71) Applicant: Derrick Poer, Apollo Beach, FL (US)

(72) Inventor: Derrick Poer, Apollo Beach, FL (US)

(21) Appl. No.: 19/205,622

(22) Filed: May 12, 2025

(51) Int. Cl. B60P 7/08

(52) U.S. Cl. CPC B60P 7/0846

(57) ABSTRACT

A device for organizing a ratchet-strap assembly including a ratchet mechanism and a strap includes a rigid buckle body having a generally planar, rectangular form with a first pair of horns projecting outwards and a second pair of horns projecting outwards, the pairs of horns defining strap-receiving channels, a first elongated slot extending through the buckle body adjacent the first lateral edge and a second elongated slot extending through the buckle body adjacent the opposite lateral edge, the slots sized to receive the strap, a wedge-shaped hook projecting from a side of the buckle body, and, a band having spaced apertures to engage the wedge-shaped hook, so as to couple with the buckle body, wherein the strap wraps around the ratchet mechanism, threaded through elongated slots and disposed in the strap-receiving channels, and wherein the band is wrapped around the buckle body and the ratchet-strap assembly.

### CROSS REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to cargo-securing equipment, and more particularly to accessories for tensioning-strap systems such as ratchet straps, cam-buckle straps, and other flat webbing tie-downs.

### BACKGROUND

Woven-web ratchet straps, cam-buckle straps, and similar tie-down assemblies have become the workhorse for securing recreational, commercial, and industrial cargo. Although the underlying ratcheting or cam mechanism reliably generates and maintains tension, the industry has not converged on an equally reliable way to manage the free-end or “slack tail” of the webbing. The most common field expedient is to tie the slack into a stopper knot or hitch around a stationary structural member. Knots, however, measurably weaken synthetic webbing—laboratory tests routinely show strength losses approaching fifty percent—and create sharp bends that concentrate wear. They are time-consuming to form and, after being tightened under load, notoriously difficult to untie, especially in wet, frozen, or contaminated conditions. Improperly dressed knots can work loose during transport, allowing the strap to unwind and the load to shift.

Some manufacturers supply auxiliary hook-and-loop keeper straps—either permanently sewn to the webbings or provided as loose accessories—to wrap around the coiled slack. While these bands are quicker than tying knots, they depend on fine textile hooks and loops that clog with mud, sand, and road debris, lose grip after repeated UV exposure, and permit the user to pull the tail free without first disengaging the fastener. Once the tail is inadvertently released, vibration can draw webbing back through the ratchet mandrel, culminating in partial or complete tension loss. Plastic clips, spring clamps, and snap-on “strap keepers” attempt to pinch the slack against the ratchet frame, but they tend to accommodate only a narrow range of webbing widths, crack in cold weather, and can be shaken loose on rough roads. Dedicated racks, reels, or wall-mounted boxes solve the storage problem in shops and warehouses, yet they contribute nothing when the straps are actually restraining cargo and are, by definition, not portable.

Because the prevailing solutions address slack management either only during active tie-down or only during storage, operators still confront tangled straps, dangling tails that abrade painted surfaces, and unpredictable reductions in working load. The lack of a universal, portable accessory that simultaneously locks the tail during use, preserves the prepared length for rapid redeployment, and organizes the entire assembly when stowed continues to burden end users with extra setup time, premature strap wear, and safety risks to both cargo and personnel.

Therefore, there remains a need to solve the problems with the prior art, namely, a more efficient and user-friendly organization system for ratchet straps, cam-buckle straps, and similar tie-down assemblies.

### SUMMARY

A device for organizing a ratchet-strap assembly is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a device for organizing a ratchet-strap assembly including a ratchet mechanism and a strap is provided that solves the above-described problems. The device includes a rigid buckle body having a generally planar, rectangular form with (i) a first pair of horns projecting from a first lateral edge of the buckle body and (ii) a second pair of horns projecting from an opposite lateral edge of the buckle body, the respective pairs of horns defining first and second strap-receiving channels, a first elongated slot extending through the buckle body adjacent the first lateral edge and a second elongated slot extending through the buckle body adjacent the opposite lateral edge, the first and second elongated slots sized to receive the strap, a first wedge-shaped hook projecting from a side of the buckle body, and, an elongated elastomeric band having a plurality of spaced apertures configured to selectively and releasably engage the first wedge-shaped hook, so as to couple with the buckle body, wherein the buckle body is configured such that the strap is wrapped around the ratchet mechanism, threaded through the first and second elongated slots and disposed in the strap-receiving channels, and wherein the elastomeric band is configured to be wrapped around the buckle body and the ratchet-strap assembly and further secured to the first wedge-shaped hook via one of the plurality of spaced apertures.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a top view of a ratchet strap organization system, according to an embodiment.

FIG. 2 is a left-side view of the ratchet strap organization system, according to an embodiment.

FIG. 3 is a bottom view of the ratchet strap organization system, according to an embodiment.

FIG. 4 is a rear view of the ratchet strap organization system, according to an embodiment.

FIG. 5 is a front view of the ratchet strap organization system, according to an embodiment.

FIG. 6 is a top perspective view of the ratchet strap organization system, according to an embodiment.

FIG. 7 is a rear perspective view of the ratchet strap organization system, according to an embodiment.

FIG. 8 is a perspective view of the belt element for the ratchet strap organization system, according to an embodiment.

FIG. 9 is a perspective view of the buckle element of the ratchet strap organization system, according to an embodiment.

FIG. 10 is a perspective view of the ratchet strap organization system under tension, according to an embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The embodiments claimed herein address the deficiencies identified in the prior art by providing a ratchet-strap organization system that secures the free end of the webbing with a mechanical interlock that eliminates the need to tie knots around the strap tail; accordingly, the webbing is not subjected to sharp bends that reduce tensile strength, and the operator is spared the time and dexterity required to form, and later untie, stopper hitches. Further, constant clamping force is supplied by the elastomeric band, which is retained under tension between wedge hooks on the buckle body. Because the band remains in controlled stretch around both the buckle body and the ratchet mechanism, vibration and cyclic loading cannot slacken the assembly; thus, the inadvertent unraveling that often occurs with hook-and-loop keeper straps is prevented. Additionally, the thermoplastic-elastomer band is impervious to clogging by mud or road grit and resists ultraviolet degradation, thereby maintaining reliable closure over extended field use.

Moreover, the claimed embodiments address issues with compatibility by accommodating a large range or webbing sizes—from approximately ¾ in. to 3 in. or more. The claimed embodiments therefore replace multiple width-specific clips or spring clamps and will not crack in low-temperature environments. Also, the claimed embodiments keep the webbing of the ratchet-strap neatly bundled for both the active tie-down phase and the stowage phase—something the fixed racks and wall boxes of the prior art cannot accomplish. Because the strap is never released from the buckle body during storage, tangles are virtually eliminated, and redeployment time is reduced to a single motion of unhooking the band from the wedge hook. Finally, the elastomeric band forms a resilient buffer between the metal ratchet frame and painted or delicate cargo surfaces, mitigating the abrasion and cosmetic damage caused by dangling slack or exposed hardware in conventional systems. Thus, the claimed embodiments solve the long-standing problems of strength loss, unintentional release, environmental failure, limited compatibility, and poor portability that characterize existing knot-based, hook-and-loop, clip-on, and rack-type solutions for ratchet-straps.

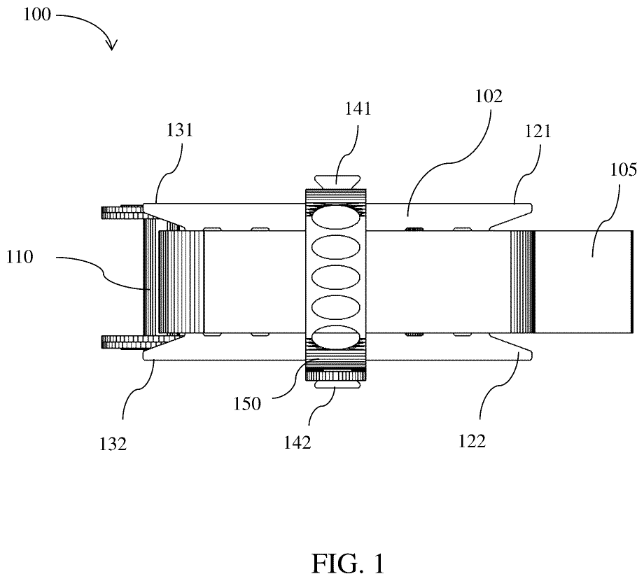

The accompanying drawings, which are incorporated in and constitute a part of this disclosure, illustrate various example embodiments. The claimed ratchet strap organization system 100 will now be described with respect to FIGS. 1 through 10.

FIG. 1 presents a top-plan view of the system 100 in its fully assembled, load-securing state. A conventional ratchet mechanism 110, only partially visible for clarity, underlies a rigid, generally rectangular buckle body 102 that is oriented such that its longitudinal axis (lengthwise axis) is parallel to the lengthwise axis of the ratchet mechanism (i.e., the longitudinal axis of the ratchet mechanism handle). A webbing strap 105 exits the ratchet mechanism and is routed in a serpentine path through the elongated slots of the buckle body. The strap further lies in a first U-shaped strap-receiving channel 902 bounded by a first pair of outward-flaring horns 121, 122. The strap is similarly seated in a second U-shaped strap-receiving channel 903 defined by a second pair of horns 131, 132. This slot-and-channel path frictionally locks the slack tail so that axial withdrawal is impossible while the strap remains laced through the slots.

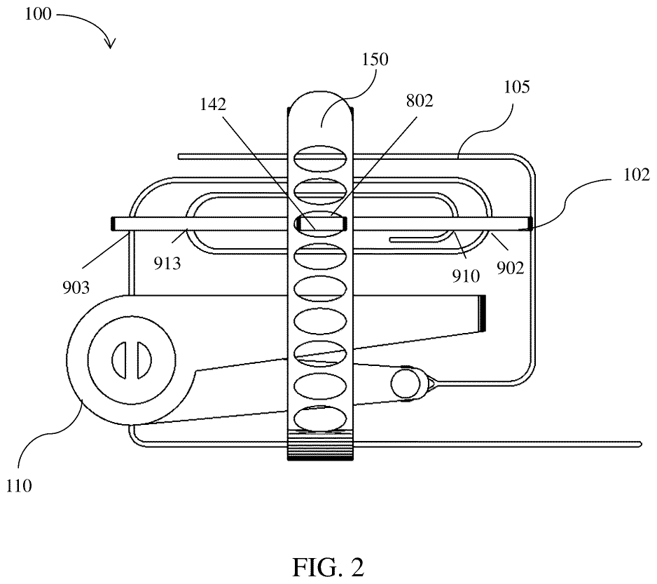

FIG. 2 is a left-side elevation that highlights the cooperative engagement between the buckle body 102 and an elongate elastomeric band 150. The band is wrapped transversely around the strap, the buckle body, and the ratchet mechanism 110, placing the band in controlled tension. A plurality of uniformly spaced apertures 802 extend along the length of the band; the aperture currently in use is stretched over a first wedge-shaped hook 142 that projects orthogonally from one side of the buckle body. The controlled stretch of the band clamps the previously described serpentine strap path in place and simultaneously serves as a resilient buffer preventing metal-to-metal or metal-to-paint contact.

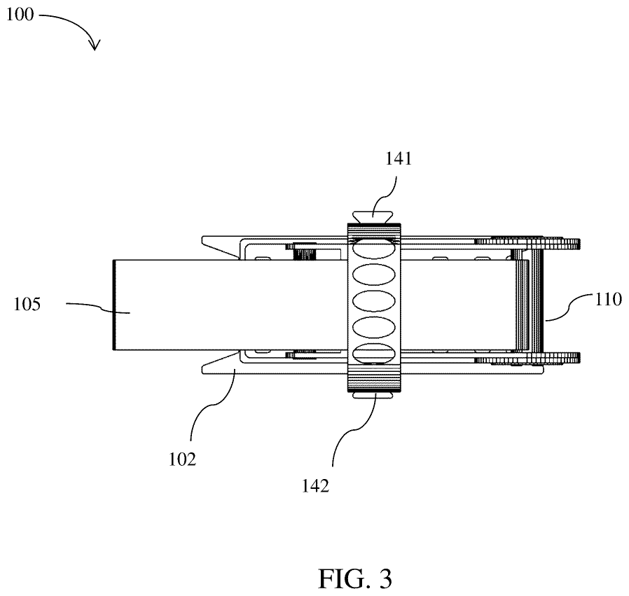

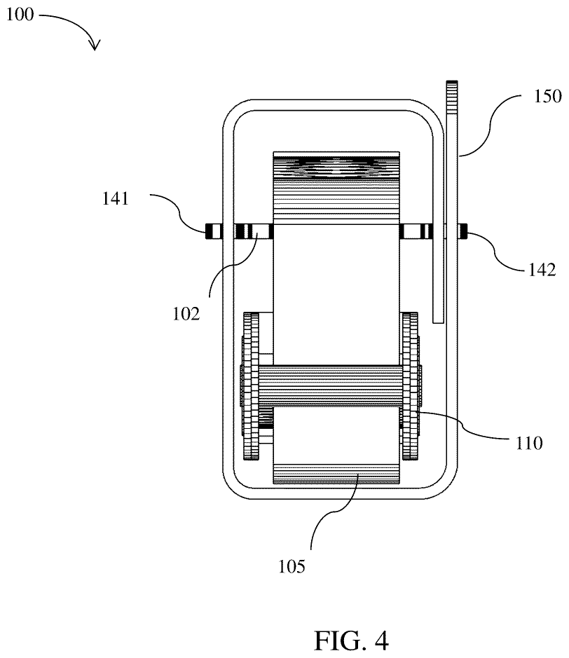

FIG. 3 illustrates the underside of the system 100, where a mirror-image second wedge-shaped hook 142 projects from the opposite side of the buckle body 102. Hook 142 allows the band 150 to be anchored from either side, giving the operator flexibility in band routing and enabling the device to function when flipped. FIG. 4 provides a rear elevation showing how the band 150 wraps completely around the strap, the buckle body, and the ratchet mechanism 110, placing the band in controlled tension. The band is coupled with both hooks 141, 142 to secure the band to the buckle and hence to the strap and ratchet mechanism.

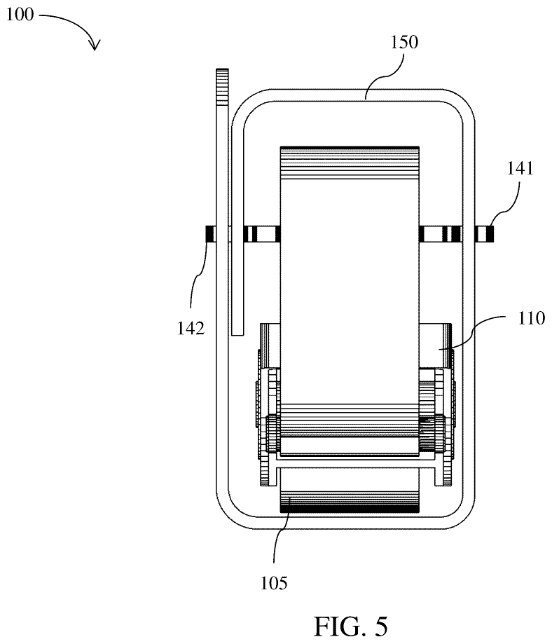

FIG. 5 is a front elevation that also shows how the band is coupled with both hooks 141 and 142 to secure the band to the buckle and hence to the strap and ratchet mechanism.

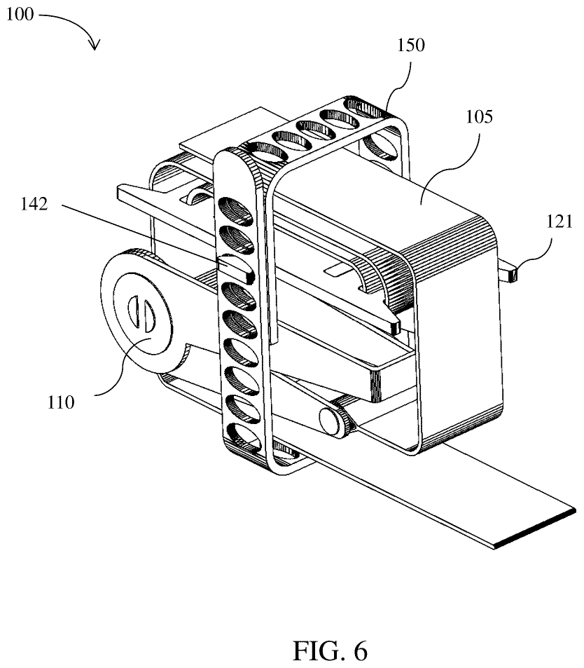

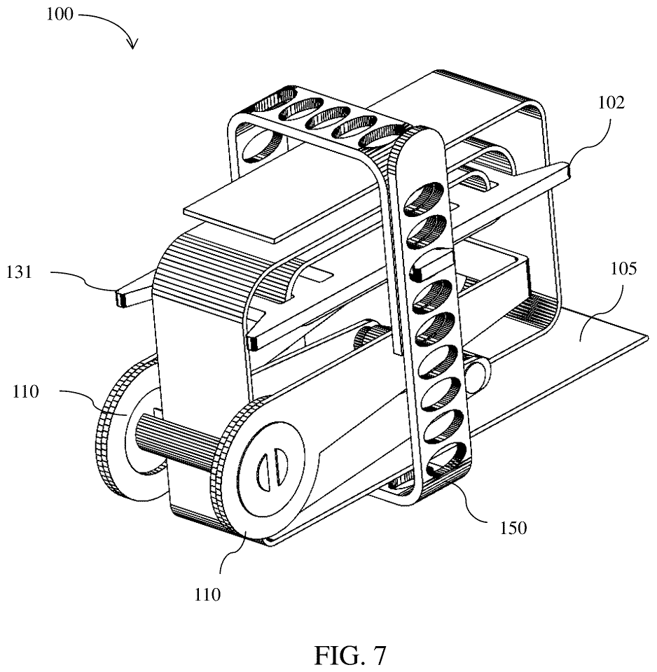

FIG. 6 depicts a top-front perspective view that integrates the elements previously described, better illustrating the “through-winding” of strap 105, the transverse wrap of elastomeric band 150, and the way the strap is placed within the strap-receiving channels of the pairs of horns 121-122, 131-132. FIG. 7 offers a complementary rear-perspective view and shows how the hook 142 interfaces with an aperture 802 along band 150.

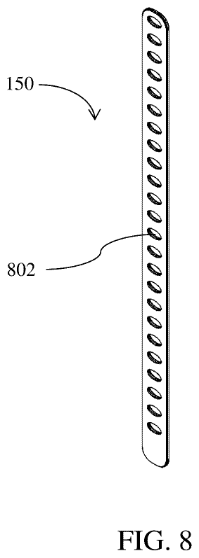

FIG. 8 isolates the elastomeric band 150 itself. In this view, the band is shown in its relaxed, un-tensioned state, revealing a ladder of oval apertures 802 distributed along the band's longitudinal centerline; the elastomeric material eases handling when stretching the band over a selected hook. The band may be molded from a UV-stable thermoplastic elastomer having an ultimate elongation of at least 300 percent, ensuring that the clamping force remains consistent over long service lives and extreme temperature swings.

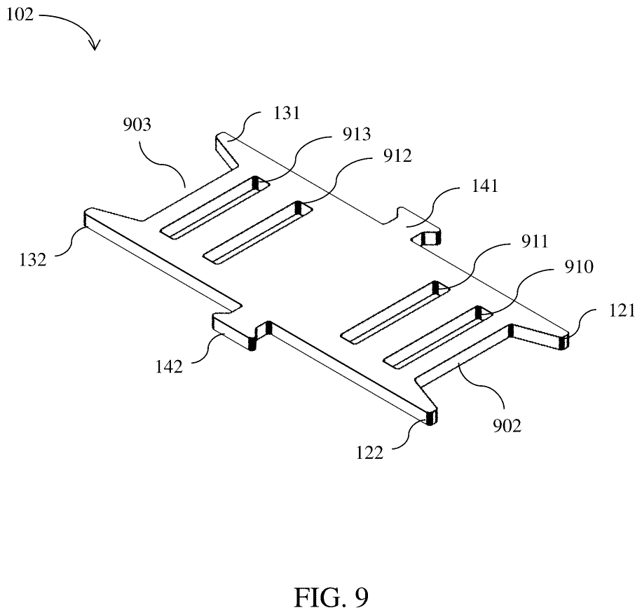

FIG. 9 isolates the buckle body 102. Both wedge-shaped hooks 141, 142 can be seen projecting from opposite sides, as can the two pairs of elongated slots 910, 911 and 912, 913 and the two pairs of horns 121-122, 131-132 that form strap-receiving channels 902, 903. Each pair of slots allows the strap 105 to be threaded four times to establish a redundant serpentine path for especially heavy-duty applications or for users who wish to bind the tail even more tightly against the buckle body. The buckle body is preferably molded from glass-fiber-reinforced nylon possessing a flexural modulus of at least 3 GPa and impact resistance sufficient to survive a 1 m drop test, thereby preventing fracture in cold climates or under rough handling.

FIG. 9 shows how the outwardly flared geometry of horns 121-122 and 131-132 accommodates strap widths ranging from approximately 19 mm (¾ in.) to 76 mm (3 in.) without modification, thereby imparting universal compatibility. The U-shaped cradles (i.e., strap-receiving channels 902, 903) formed by the horn pairs keep the strap centered and prevent lateral creep during high-vibration transport.

FIG. 9 also emphasizes the engagement barb at the distal end of wedge hooks 141, 142. When an aperture 802 is stretched over the barb, the elastic memory of band 150 forces the aperture edge into a recess behind the barb, resisting disengagement under tensile loads caused by road shock or wind.

FIG. 2 shows how the webbing strap 105 exits the ratchet mechanism and is routed in a serpentine path: it first passes through strap-receiving channel 903 (bounded by a pair of outward-flaring horns 131, 132), it travels over the top surface of the buckle body, it passes through strap-receiving channel 902 (bounded by a pair of outward-flaring horns 121, 122), it travels under the bottom surface of the buckle body, it threads through the elongated slot 913 to the top surface of the buckle body, it travels across the top surface of the buckle body, and then it finally enters the elongated slot 910. In another embodiment, the strap is further threaded through the elongated slots 911, 912.

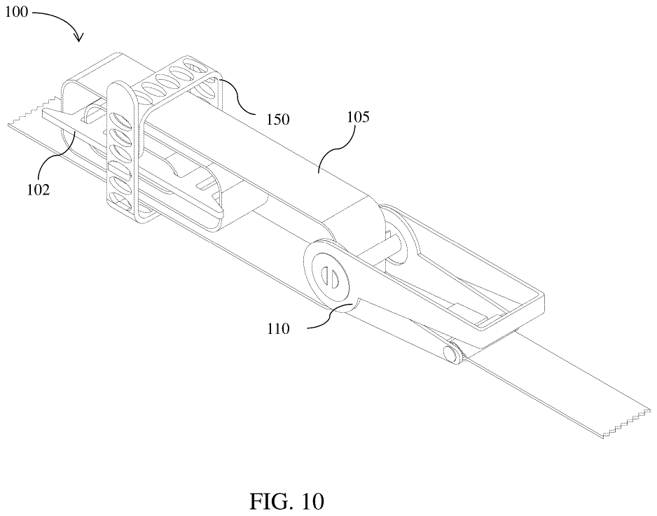

FIG. 10 is a perspective view of the ratchet strap organization system 100 under tension, according to an embodiment. FIG. 10 shows how the ratchet mechanism 110 is not surrounded by, or within the holding area of, the band 150 since the ratchet mechanism is under tension. Thus, in this orientation, the band 150 surrounds the buckle 102 and the tail end of the strap 105, allows the tail to be bundled neatly for storage.

Taken together, FIGS. 1-10 demonstrate how buckle body 102, elastomeric band 150, and strap 105 cooperate with the ratchet mechanism 110 to form an integrated system that (i) captures and locks the slack tail without knots, (ii) maintains constant clamping tension resistant to vibration and environmental fouling, (iii) accommodates a wide range of webbing widths without additional hardware, (iv) protects finished surfaces from damage, and (v) allows the entire assembly to be bundled neatly for storage.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device for organizing a ratchet-strap assembly including a ratchet mechanism and a strap, the device comprising:
a rigid buckle body having a generally planar, rectangular form with (i) a first pair of horns projecting from a first lateral edge of the buckle body and (ii) a second pair of horns projecting from an opposite lateral edge of the buckle body, the respective pairs of horns defining first and second strap-receiving channels;
a first elongated slot extending through the buckle body adjacent the first lateral edge and a second elongated slot extending through the buckle body adjacent the opposite lateral edge, the first and second elongated slots sized to receive the strap;
a first wedge-shaped hook projecting from a side of the buckle body; and
an elongated elastomeric band having a plurality of spaced apertures configured to selectively and releasably engage the first wedge-shaped hook, so as to couple with the buckle body,
wherein the buckle body is configured such that the strap is wrapped around the ratchet mechanism, threaded through the first and second elongated slots and disposed in the strap-receiving channels, and wherein the elastomeric band is configured to be wrapped around the buckle body and the ratchet-strap assembly and further secured to the first wedge-shaped hook via one of the plurality of spaced apertures.

2. The device of claim 1, wherein the buckle body further includes a second wedge-shaped hook projecting from a side opposite the first wedge-shaped hook, and wherein the elastomeric band is configured to be secured to the second wedge-shaped hook via another one of the plurality of spaced apertures.

3. The device of claim 2, wherein the first pair of horns flare outward to form a U-shaped cradle comprising the first strap-receiving channel and wherein the second pair of horns flare outward to form a U-shaped cradle comprising the second strap-receiving channel.

4. The device of claim 3, wherein each horn of the first and second pair of horns is substantially triangular in shape.

5. The device of claim 4, wherein each slot of the first and second elongated slots are substantially rectangular in shape.

6. The device of claim 5, wherein each aperture of the plurality of spaced apertures are substantially oval in shape.

7. The device of claim 6, wherein the wedge-shaped hook terminates in an enlarged barb that engages an edge of an aperture in the elastomeric band to resist disengagement under tensile loads.

8. The device of claim 7, wherein the elastomeric band is formed of a UV-resistant thermoplastic elastomer having an ultimate elongation of at least 300 percent.

9. The device of claim 8, wherein the buckle body is molded from glass-fiber-reinforced nylon imparting a flexural modulus of at least 3 GPa and an impact strength sufficient to withstand a 1-meter drop test.

10. The device of claim 9, wherein the buckle body is molded from plastic.

11. A device for organizing a ratchet-strap assembly including a ratchet mechanism and a strap, the device comprising:
a rigid buckle body having a generally planar, rectangular form with (i) a first pair of horns projecting from a first lateral edge of the buckle body and (ii) a second pair of horns projecting from an opposite lateral edge of the buckle body, the respective pairs of horns defining first and second strap-receiving channels;
a first pair of elongated slots extending through the buckle body adjacent the first lateral edge and a second pair of elongated slots extending through the buckle body adjacent the opposite lateral edge, the first and second pairs of elongated slots sized to receive the strap;
a first wedge-shaped hook projecting from a side of the buckle body; and
an elongated elastomeric band having a plurality of spaced apertures configured to selectively and releasably engage the first wedge-shaped hook, so as to couple with the buckle body,
wherein the buckle body is configured such that the strap is wrapped around the ratchet mechanism, threaded through the first and second pairs of elongated slots and disposed in the strap-receiving channels, and wherein the elastomeric band is configured to be wrapped around the buckle body and the ratchet-strap assembly and further secured to the first wedge-shaped hook via one of the plurality of spaced apertures.

12. The device of claim 11, wherein the buckle body further includes a second wedge-shaped hook projecting from a side opposite the first wedge-shaped hook, and wherein the elastomeric band is configured to be secured to the second wedge-shaped hook via another one of the plurality of spaced apertures.

13. The device of claim 12, wherein the first pair of horns flare outward to form a U-shaped cradle comprising the first strap-receiving channel and wherein the second pair of horns flare outward to form a U-shaped cradle comprising the second strap-receiving channel.

14. The device of claim 13, wherein each horn of the first and second pair of horns is substantially triangular in shape.

15. The device of claim 14, wherein each slot of the first and second pairs of elongated slots are substantially rectangular in shape.

16. The device of claim 15, wherein each aperture of the plurality of spaced apertures are substantially oval in shape.

17. The device of claim 16, wherein the wedge-shaped hook terminates in an enlarged barb that engages an edge of an aperture in the elastomeric band to resist disengagement under tensile loads.

18. The device of claim 17, wherein the elastomeric band is formed of a UV-resistant thermoplastic elastomer having an ultimate elongation of at least 300 percent.

19. The device of claim 18, wherein the buckle body is molded from glass-fiber-reinforced nylon imparting a flexural modulus of at least 3 GPa and an impact strength sufficient to withstand a 1-meter drop test.

20. The device of claim 19, wherein the buckle body is molded from plastic.
